(19) United States
(12) Patent Application Publication
(10) Pub. No.: US 2017/0184079 A1
(43) Pub. Date: Jun. 29, 2017

(54) Tasoptic Lens - Solar Energy

(71) Applicant: Tasos Aggelopoulos, Honolulu, HI (US)

(72) Inventor: Tasos Aggelopoulos, Honolulu, HI (US)

(73) Assignee: Tasos Inc., Honolulu, HI (US)

(21) Appl. No.: 14/980,690

(22) Filed: Dec. 28, 2015

(51) Int. Cl. F03G 6/06

(52) U.S. Cl. CPC F03G 6/065

(57) ABSTRACT

A system for harnessing solar energy using heating applications to generate intense heat for steam boilers and all other water heating applications. Electricity is generated using a steam turbine engine that employs a bank of four biconvex octave lenses, with each having specific sizes, radii, arc convexity and distances from one another in mathematical orderliness in compliance with the Geometry of Space and the Law of Octave of Elements of Matter. The focal points of these lenses are positioned onto a boiler tank consisting of a pair of flat steel sheets in which water runs through from one side and comes out as steam on the other side of it. The steam is then fed into a steam turbine engine to generate electricity. A dual axle sun tracker is adjusted beneath the boiler plate to track the sun's movement from both east to west and north to south at all times. A system of highly conductive carbon rods is assembled on top of the Tasoptic lenses to be activated and subsequently produce an intense arc of hot white light to simulate the sun's parallel rays during the night and cloudy days for the continuity of operation at all times.

The present U.S. Patent Application claims the priority filing of U.S. Provisional Patent Application Ser. No. 62/099,866 filed on Jan. 5, 2015.

### FIELD OF INVENTION

The present novel invention relates to a system that harnesses solar energy via a Tasoptic Lens that is comprised of four biconvex octave lenses by generating heat for steam turbine engines, water purification systems, and the production of heat and hot water. The system is particularly applicable for replacing the conventional method of using photovoltaic systems for converting electrical energy, hydrocarbon and fossil fuel to heat in steam turbine engines, commercial boilers, residential hot water heaters, space and hydronic heating systems as well as all other applications where intense heat is required.

### BACKGROUND OF THE INVENTION

It has previously been proposed that lenses of many different sizes and types, including conventional photovoltaic (PV) panel designs, may be used to harness the sun's rays for heat and steam to generate electricity for use particularly in steam engines, commercial boilers and residential water heaters. Proposals that seek to avoid the use of complex mechanisms, unnecessary electronic circuitries and conventional methods of photovoltaic systems that convert solar and electrical energy to heat have generally called for an efficient solar system to generate intense heat that can produce immense amounts of steam for use in steam turbine engines and usage in all other heating applications such as commercial boilers, residential water heaters and aquatic farms.

One such proposal includes U.S. patent application Ser. No. 09/532,009 to John Wing-Yan Tang and Tei-Yan Tang, issued on Dec. 11, 2001, discloses using solar cells embedded in between two panes of glass in windows to harness the power of solar energy coupled with additional direct electrical current and then inverted into alternate current via permanent electrical circuit inverters. An oscillator attached to the solar cell (Ferrite Core) is then fed into circuit breakers for use in buildings.

Another proposal includes the publication of U.S. patent application No. 389,124 A to Edward Weston, issued on Sep. 4, 1888, discloses using concentrated solar rays upon thermoelectric elements wherein two bodies of dissimilar metals are placed side by side and united together at their ends while everywhere else is insulated from one another. When several of these such elements are assembled in a series, an electrical current can be produced by increasing the amount of heat.

Another proposal includes the publication of U.S. patent application No. 8,410,351 B1 to Bingwu Gu, issued on Apr. 2, 2013, discloses using solar rays to generate electricity by exposing a transparent fluid to intense heat of the sun's rays collected by a concentrator. The concentrated heat and sun's rays thus produced is to strike a solar cell array in the fluid to generate electricity.

Other proposals include the conventional method of creating a photovoltaic system by manufacturing panels which are made of toxic elements such Boron, and expensive materials such as silver, to convert solar energy to electricity.

Taking this into consideration, the prior art proposals have had significant disadvantages in terms of complexity and unpredictability of sunlight availability as well as producing nominal amounts of electricity at a high cost. Also, conventional methods of installing photovoltaic solar energy systems require a substantial amount of physical space and have transformed building rooftops into unsightly views. Furthermore, the art proposals have implemented clumsy calculations by using unnecessary complex mechanisms and electronic gadgets to regulate the supply of electrical energy. It would be highly desirable to harness solar energy by creating a simple and compact mechanism that is scalable using the correct scientific method. This may be achieved by crafting a bank of four biconvex octave lenses that work in cohesion with the working order of Geometry of Space and the Law of Octave of Elements of Matter which compress the sun's parallel rays in inverse cube ratio within each octave progression. This particular mechanism may generate a continuous supply of immense heat at any temperature desirable for usage in a broad array of heating apparatuses.

It would be further desirable to provide a simple mechanism to the market that is manufactured at very economical prices. By doing so, we may reduce the current cost of electrical energy production and eliminate the use of photovoltaic panels. Subsequently, this will also reduce the amount of electrical cable assembly traditionally required, fulfills the demand of World Energy Conservation Organizations and adds up to the world market resources and wealth of the planet.

### SUMMARY OF THE INVENTION

In accordance with the present invention, a system for heating water and generating steam is adapted for use in steam turbine engines, water purification systems and commercial boilers. The system employs a bank of twelve sets of lenses, with each set comprised of four biconvex octave lenses.

Each of these four octave lenses are crafted per application requisites with different sizes and convexity to converge and intensify the sun's parallel rays onto focal points. They are positioned horizontally and spaced in inverse cube ratio upon one another in mathematical orderliness to comply with the Geometry of Space and the Law of Octave of Elements of Matter. These lenses converge and multiply the sun's parallel rays through one another. Each set of lenses is placed in a metallic cone that is coated with a reflective surface on the interior. A flexible light guide tube is attached to the apexes of each cone to guide the converged parallel light of the sun onto the surface of a flat steel boiler tank in which water flows into it from one side and comes out as steam on the other side. The steam may then be used in any application required, especially for adapting it to steam turbine engines to generate electricity.

An assembly comprised of twelve sets of lenses is constructed on a platform that possesses a dual actuator underneath the platform that tracks the sun's movement from both east to west and north to south in order keep the lenses perpendicular at 90° to the sun's direction at all times. A mechanism comprised of an array of super conductive carbon rods is attached onto space heating coils assembled above the lenses to create a luminous arc of intense white light to insure the continuity of the system to produce steam, simulating the sun's white parallel rays during the night as well as the days which are obscured by cloud cover. A concave reflective mirror cover is positioned above the carbon rod assembly to further reflect the parallel rays and the heat of the arcs onto the surface of the assembly of the lenses.

In a preferred embodiment, the reflective cones which hold the four octave lenses are half-shaped circles and folded to create 60° inclinations from the apexes. The reflective surface is on the inside of the cones, and holes are drilled into the apex of each cone. The four lenses are then assembled within the cones in mathematical orderliness in inverse cube ratio to comply with the Geometry of Space and the Law of Octave of Elements of Matter.

The fourth octave lens is then lowered into the cones to engage into its position within the bottom of the cone. The third octave lens is then lowered into the cones to sit in precise octave position in accordance to its size which is two times larger in diameter than the fourth octave lens. The second octave lens, having a diameter that is two times larger than the third octave lens, is then lowered into its position which is twice the distance of the fourth octave lens to the third octave lens. The first octave lens is two times larger than the second octave lens and is lowered to sit into its position, which is distanced two times farther than the distance of the third octave lens from the second octave lens.

The converging sun's rays are collected from a 180° radius through the convexity of the first octave lenses and are focused onto the center of the second octave lenses below it. When the sun's light travels through the first octave lenses, it is compressed and multiplied four times by the time it reaches the center of the second octave lenses. The second octave lenses compress the rays of the sun and multiply them four more times and focus them onto the center of the third octave lenses below them.

The third octave lenses compress the rays again, multiply them four times further and focus them onto the center of the fourth octave lenses below them. At this time, the fourth octave lenses compress the sun's light and multiply the rays four times more. By then, the power generated by the compression of the sun's rays has been multiplied sixty four (64) times and has reached a maximum of two hundred fifty six (256) times, which is approximately five thousand (5000) times the heat produced by the sun's light.

Flexible light guides are attached to the apexes of the cones and directed to the surface of the steel boiler. These flexible light guides are equal in length and focus the collected sun's rays onto the surface of the steel plate of the boiler to vaporize the flowing water inside the boiler into super steam to be fed into steam turbine engines or for use in water purification systems and commercial boilers.

In a preferred embodiment, the light guides are positioned above the surface of a rectangular steel boiler tank containing a cavity that is filled with water or liquid Dynalene. A finned copper tube coiled within the cavity is attached to a water input flow on one side and connected to a steam output flow on the other side. The boiler tank has a pressure relief valve and temperature gauge to monitor the desirable heat. The tank sits on a dual actuator sun tracker to track the sun's movement from both east to west and north to south at all times.

In a preferred embodiment, a mechanism comprised of an array of super conductive carbon rods is assembled above the lenses. These carbon rods are composed of sets of two with each set having a space heating coil attached to the positive poles of the carbon rods that act as resistors and are attached to the electricity. Upon switching on the electrical current, the carbon rods create intense and spontaneous luminescent arcs of light that simulate the sun's parallel rays during the night as well as during the days which are obscured by cloud cover. A concave-shaped reflective sheet of aluminum alloy is adjusted above the array of the carbon rods to reflect the luminescence and heat of the arcs back onto the surface of the lenses for further intensity.

As may be required for the intended capacity of generating immense amounts of heat for usage in steam turbine engines or water purification systems, multiple banks of lenses or additional sets of lenses may be assembled together in a series.

### BRIEF DESCRIPTION OF THE DRAWING

FIG. 1 is a diagram illustrating the complete Tasoptic Lens System during sunny days.

FIG. 2 is a diagram illustrating an assembly of super conductive carbon rods having space heating coils attached to the positive poles of each lead and a reflective metal sheet constructed above the array of carbon rods.

FIG. 3 is a diagram illustrating the complete Tasoptic Lens System during the night or on cloudy days.

FIG. 4 is a diagram illustrating four individual biconvex octave lenses positioned in mathematical orderliness in inverse cube ratio comprising the Tasoptic Lens.

FIG. 5 is a diagram illustrating all four of the lenses in their octave positions in compliance with the Geometry of Space and the Law of Octave of Elements of Matter.

FIG. 6 is a diagram illustrating a half circle of a reflective metal sheet that folds into a cone in order to hold all of the biconvex octave lenses in place.

FIG. 7 is a diagram illustrating a bank of four biconvex octave lenses positioned in a reflective cone with flexible light guide tubes to direct the sun's focal points onto the surface of the boiler tank.

FIG. 8 is a diagram illustrating flexible light guide tubes pointing onto the surface of the boiler tank.

FIG. 9 is a diagram illustrating an assembly of twelve (12) sets of Tasoptic Lens Systems positioned on a platform.

### DETAILED DESCRIPTION OF THE INVENTION

In the following detailed description of the invention, certain preferred embodiments are illustrated providing specific details of implementation. The principles of the invention are deemed to have broad applications when setting specific sizes, arc radii and convex lenses in octave positions spaced in specific geometric ratios for generating heat, steam and water purification applications. Those skilled in the art will recognize that other variations, equivalents and modifications may be made given the disclosed principles of the invention.

An overall architecture for a system in accordance with the present novel invention is described below for achieving an intense amount of heat by using solar energy adapted for use in steam turbine engines, commercial steam boilers and water purification systems. During water distillation using ocean saltwater, the slurry salt and other mineral mixtures may be combined with Sulfite and Calcium Carbonate products to produce many new material compositions of commercial value. The system is described as particularly adapted for use in steam turbine engines.

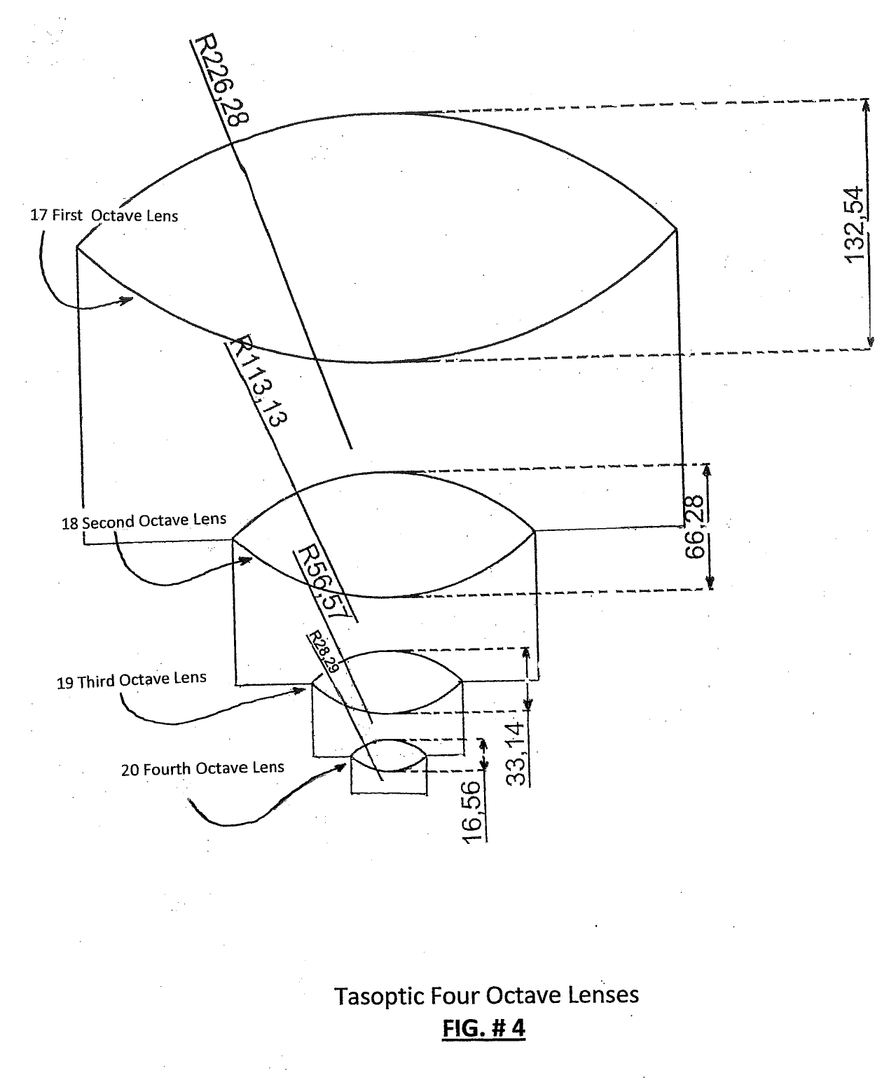

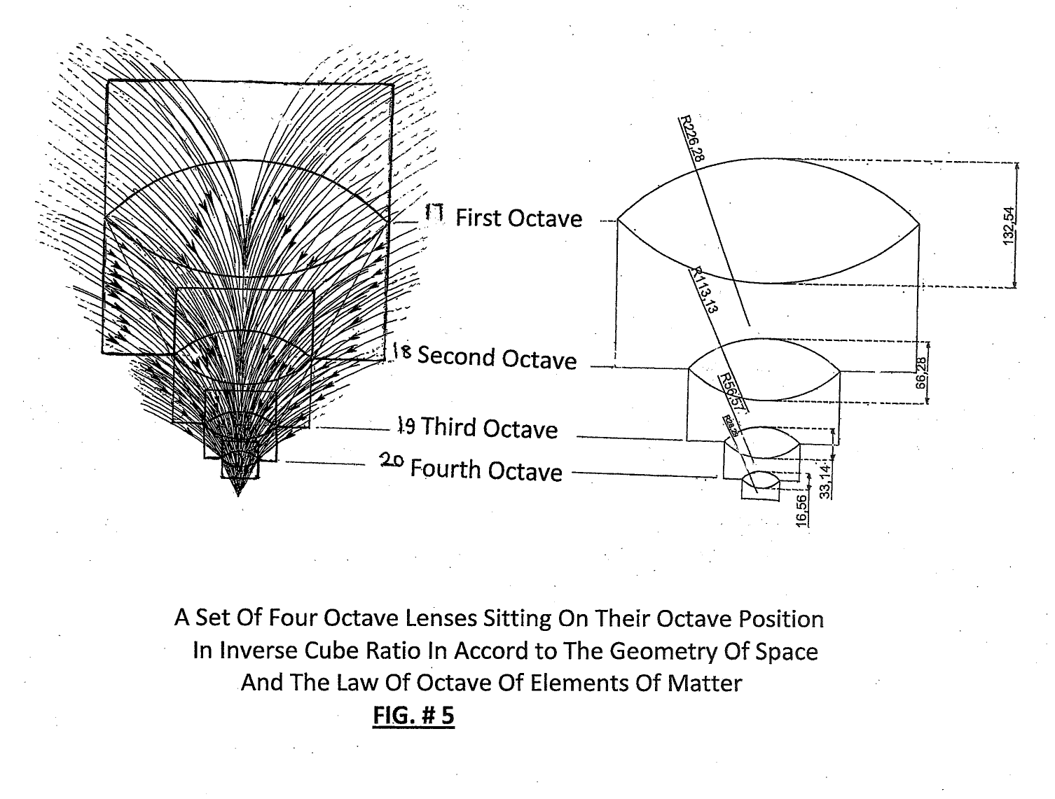

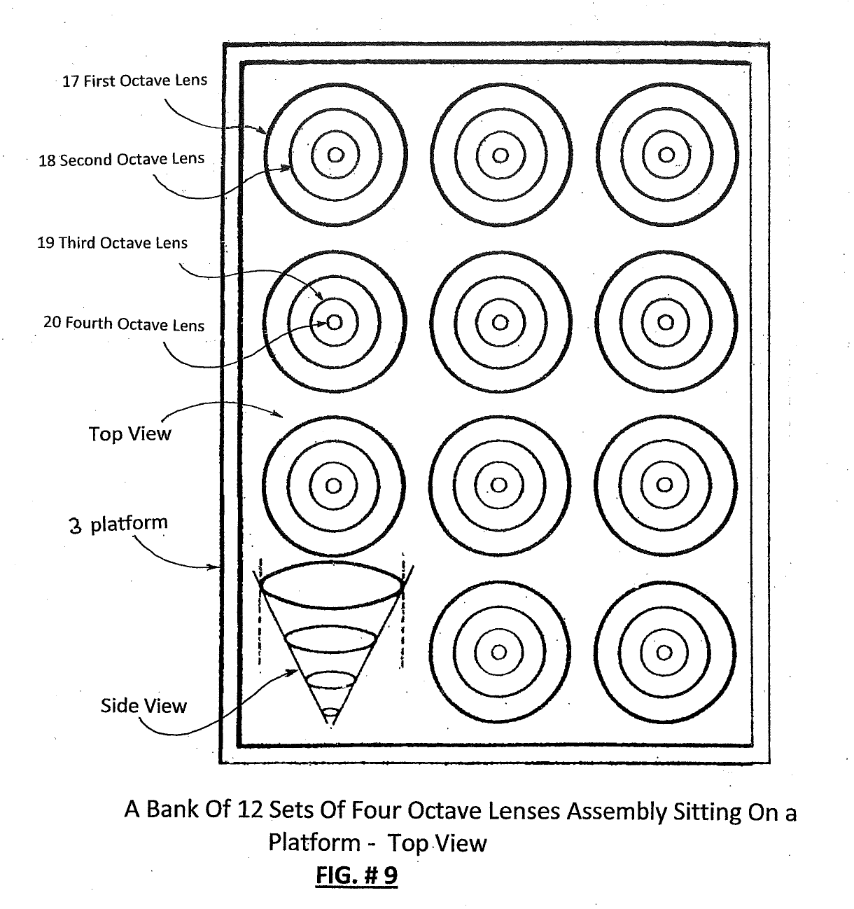

Referring to FIG. 4, the Tasoptic Lens System is comprised of four biconvex octave lenses made of glass having different arc curvatures and diameters. These lenses are placed in their positions horizontally in mathematical orderliness in inverse cube ratio in compliance with the Geometry of Space and the Law of Octave of Elements of Matter. Referring to FIG. 9, there are twelve sets of Tasoptic Lens Systems positioned on a single platform 3. These lenses multiply the parallel rays of the sun's light into short waves and fast motion of visible white light. Referring to FIG. 5, the first set of octave lenses 17 converges the sun's parallel rays 180° radially into a focal point in the centering position exactly at 160.00 mm (6.29 in) below the first array of the first octave lenses 17. These lenses are 320.00 mm (12.59 in) in diameter and have an arc curvature and radius of 226.28 mm (8.90 in).

By now, the heat and compression of the sun's rays have been multiplied four times. The size of the focal point is 4 mm in diameter. The second set of octave lenses 18 converges the rays further and multiplies the power of their heat and compression four more times, and focuses these rays 80.00 mm (3.15 in) into the center of the third octave lenses 19 below them. These lenses have a diameter of 160.00 mm (6.30 in) and an arc curvature and radius of 113.13 mm (4.45 in).

The third set of octave lenses 19 converges these rays further and multiplies the power of their heat and compression four more times and focuses the rays 40.00 mm (1.57 in) into the center of the fourth octave lenses 20 below them. These lenses have a diameter of 80.00 mm (3.15 in) and an arc curvature and radius of 56.57 mm (2.23 in). The fourth set of octave lenses 20 converges these rays and multiplies the power of their heat and compression four more times. These lenses have a diameter of 40.00 mm (1.57 in) and an arc curvature and radius of 28.29 mm (1.11 in).

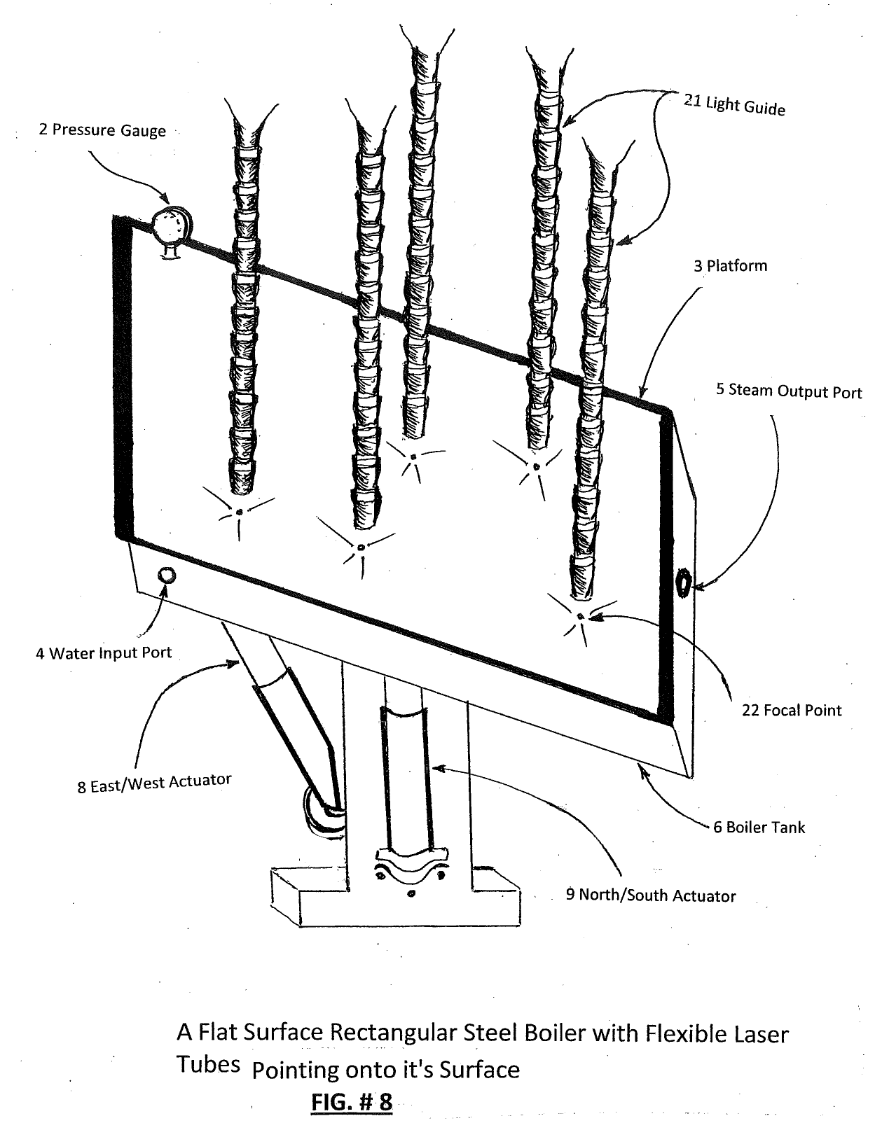

Referring to FIG. 8, the rays touch the surface of the steel boiler tank 6, and the diameter of the focal points 22 of these rays are as small as a pinhead. The heat of these rays has reached a temperature that is 5,000 times hotter than the sun's heat. These focal points 22 have the ability to cut steel upon contact and vaporize water spontaneously.

Referring to FIG. 4, the four biconvex octave lenses comprising the Tasoptic Lens all have the same multiplying power. The thickness of the first octave lens 17 measuring from the top dead center to the bottom dead center is 132.54 mm (5.22 in). The thickness of the second octave lens 18 measuring from the top dead center to the bottom dead center is 66.28 mm (2.61 in). The thickness of the third octave lens 19 measuring from the top dead center to the bottom dead center is 33.14 mm (1.30 in). The thickness of the fourth octave lens 20 measuring from the top dead center to the bottom dead center is 16.56 mm (0.65 in).

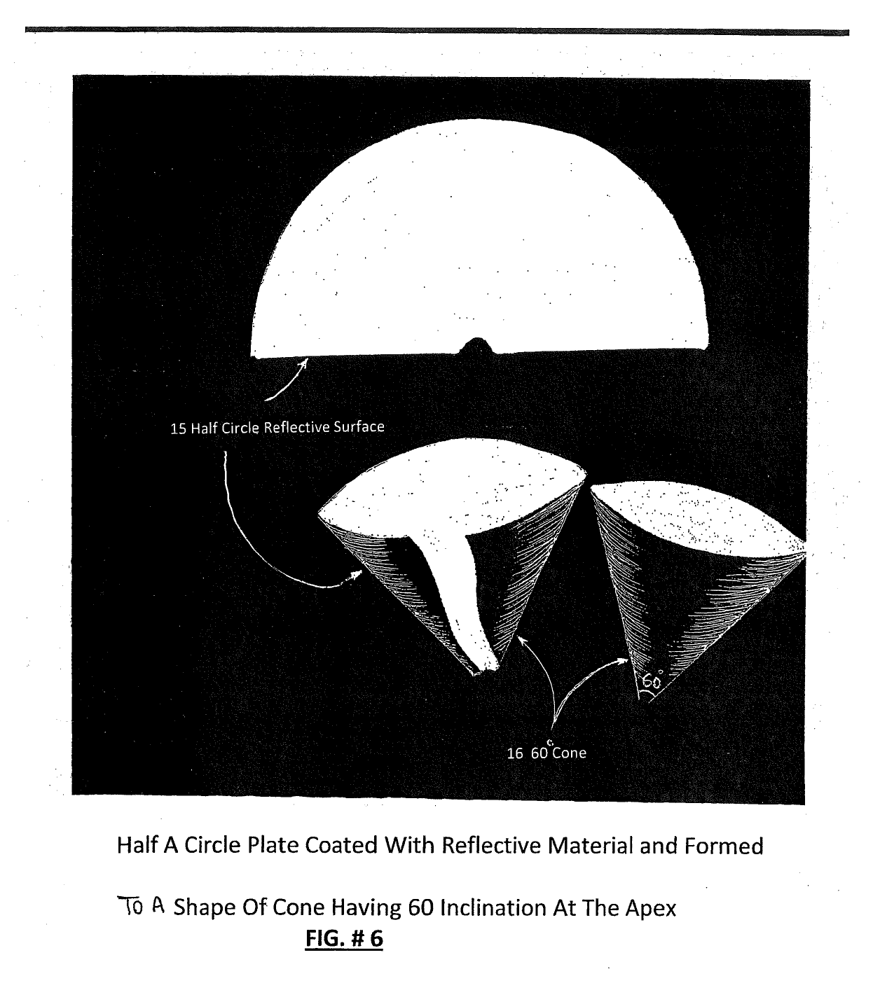

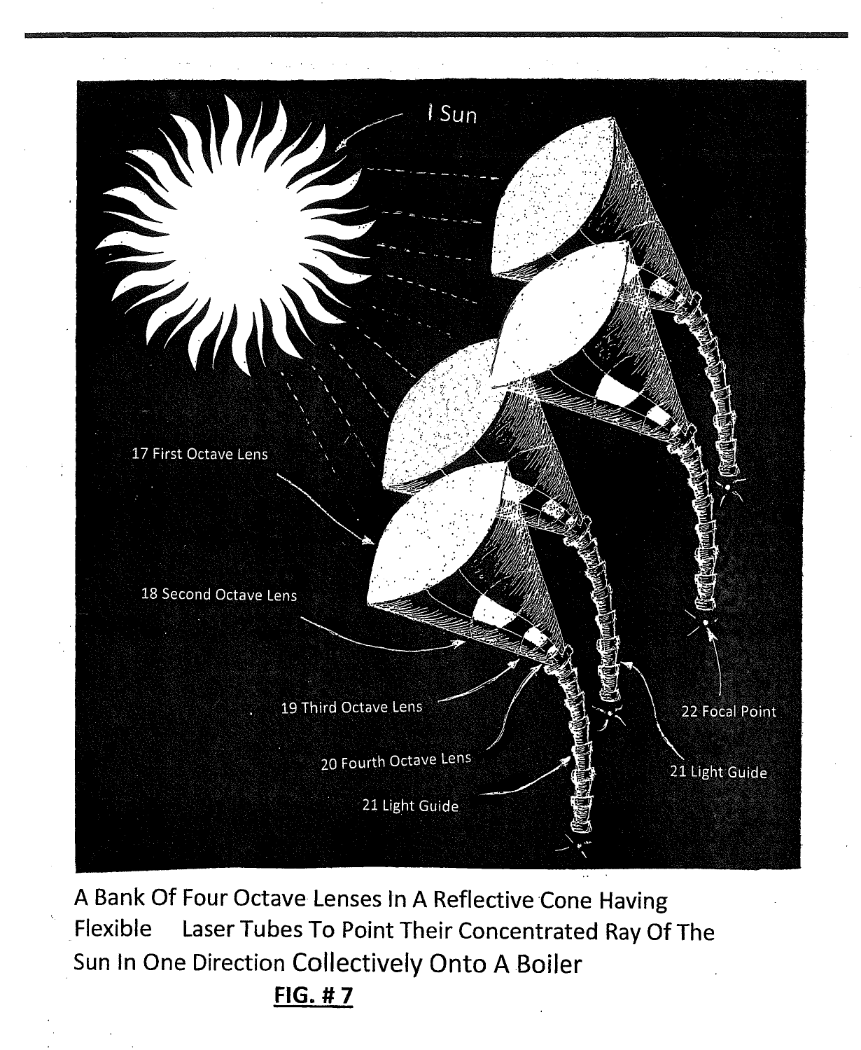

Referring to FIG. 7, each of the four octave lenses are embedded into a metallic cone coated with a reflective material on the inside surface. Referring to FIG. 6, the cones are made from a half circle 15 cut from a metal sheet and folded to become a cone 16 at a 60° inclination from the apex. A hole is bored into the apexes of these cones to allow for the focal points 22 of the rays to travel through them into flexible light guide tubes 21 that are connected to the apexes of each cone.

Referring to FIG. 9, this assembly of lenses can be one of many series of such assemblies or banks. Multiple sets of Tasoptic Lenses may be assembled under one parallel ray of light. The light may be concentrated through these lenses onto a pair of hot metal plates in which water may be pumped in between them at the water input port 4 and exit as steam at the steam output port 5. The compressed steam may lead directly to a dynamo to generate electricity or a reactor for purifying polluted river water and ocean salt water.

Referring to FIG. 8, the boiler tank 6 is made of 15.87 mm (0.625 in) thick steel. The rectangular shape of the boiler is 121.92 cm (48.00 in) wide, 243.84 cm (96.00 in) long and 12.70 cm (5.00 in) high. This tank is filled with water or liquid Dynalene. A finned copper coil tube starts from the water input port 4 and coils through the tank to the steam output port 5. The steam is then fed into a steam turbine engine to generate electricity or for usage in water purification systems and commercial boilers.

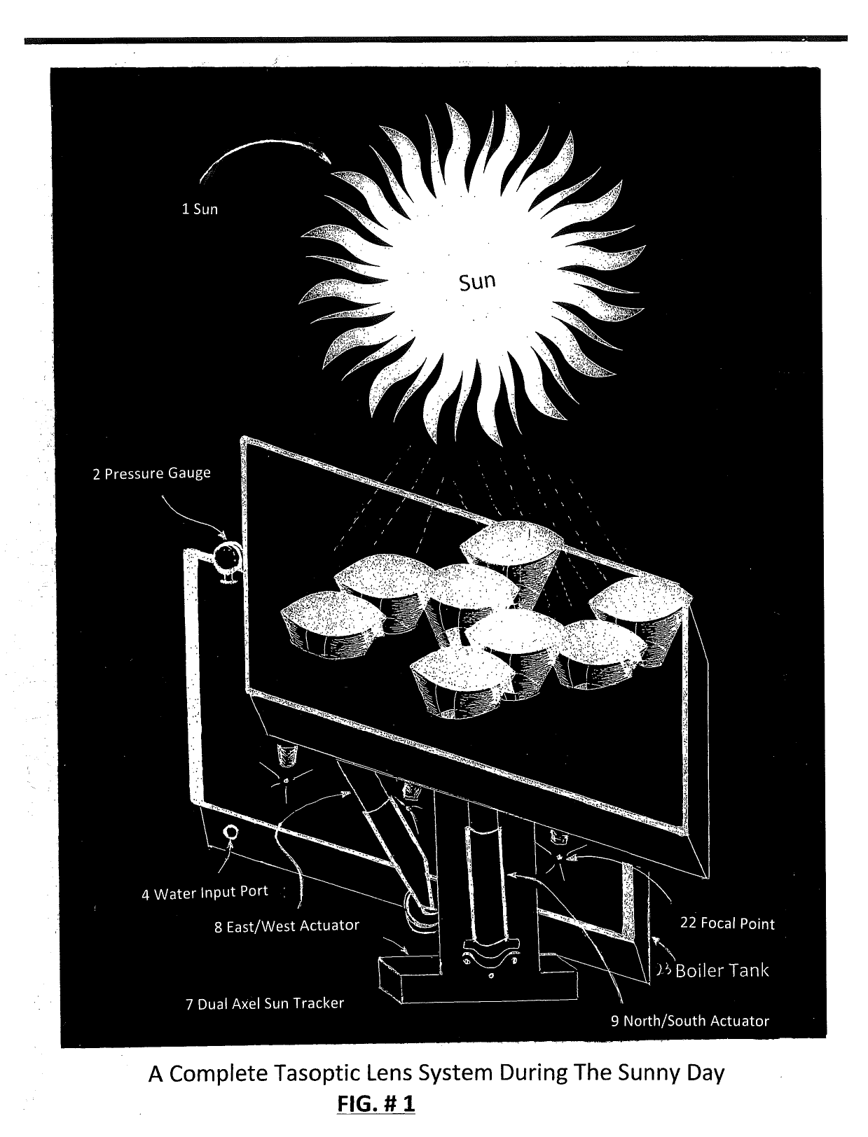

Referring to FIG. 1, a dual actuator sun tracker 7 is mounted with a bracket under the platform in which the assembly of the lenses is perpendicular to the sun's rays at 90° at all times. One of the actuators tracks the sun's movement from east to west 8 while the other actuator tracks the sun's movement from north to south 9.

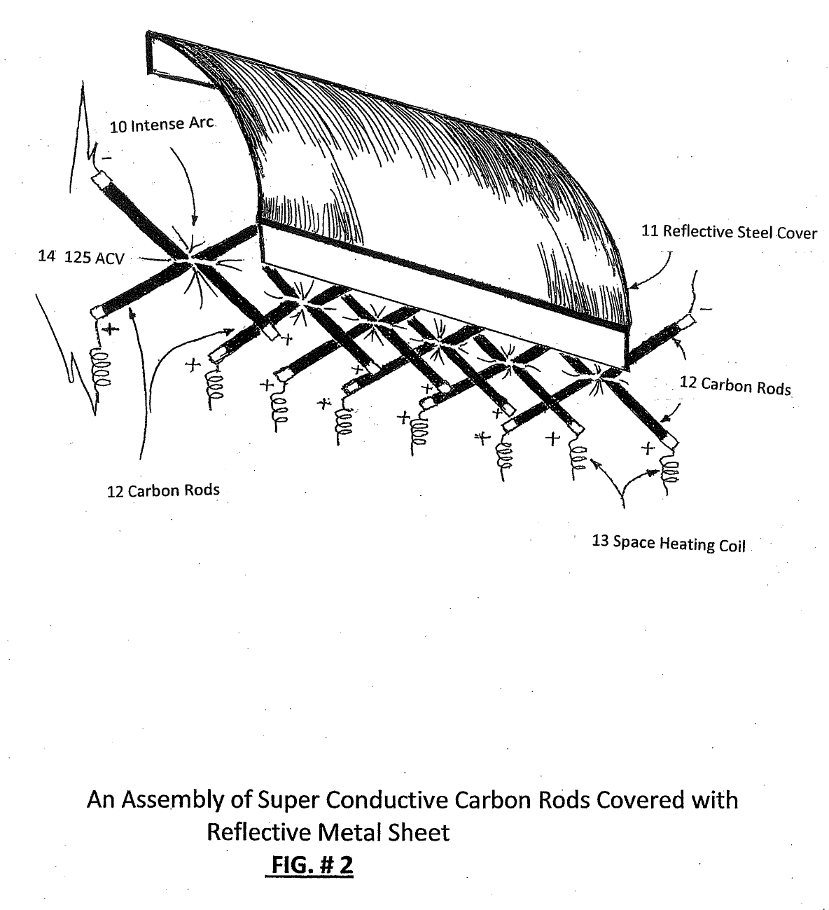

In order to overcome obstruction from the clouds and darkness at night, a mechanism comprised of an assembly bank of super conductive carbon rods 12 is positioned above the lenses as indicated in FIG. 2, to continuously simulate the white parallel light of the sun's rays. These carbon rods 12 are 19.05 mm (0.75 in) in diameter and 69.60 cm (24.00 in) long. They are attached to 1500 Watt space heating coils 13 that act as resistors between the positive poles of the carbon rods and the positive leads of the electrical lines 14.

Referring to FIG. 2, these rods are made of super conductive carbon materials. One side of the carbon rods is attached to the negative leads of the electrical lines while the other side is connected to the positive leads of the electrical lines. Space heating coils 13 are integrated in series between the positive leads of the electrical lines and the positive poles of the carbon rods 12. They respond to the “power on” switch and create a luminescent arc of intense white parallel light rays 10. This is to ensure the continuity of generating electricity twenty four (24) hours a day. A reflective concave mirror cover 11 is constructed above the carbon rod assembly to reflect the rays back onto the assembly of Tasoptic Lenses.

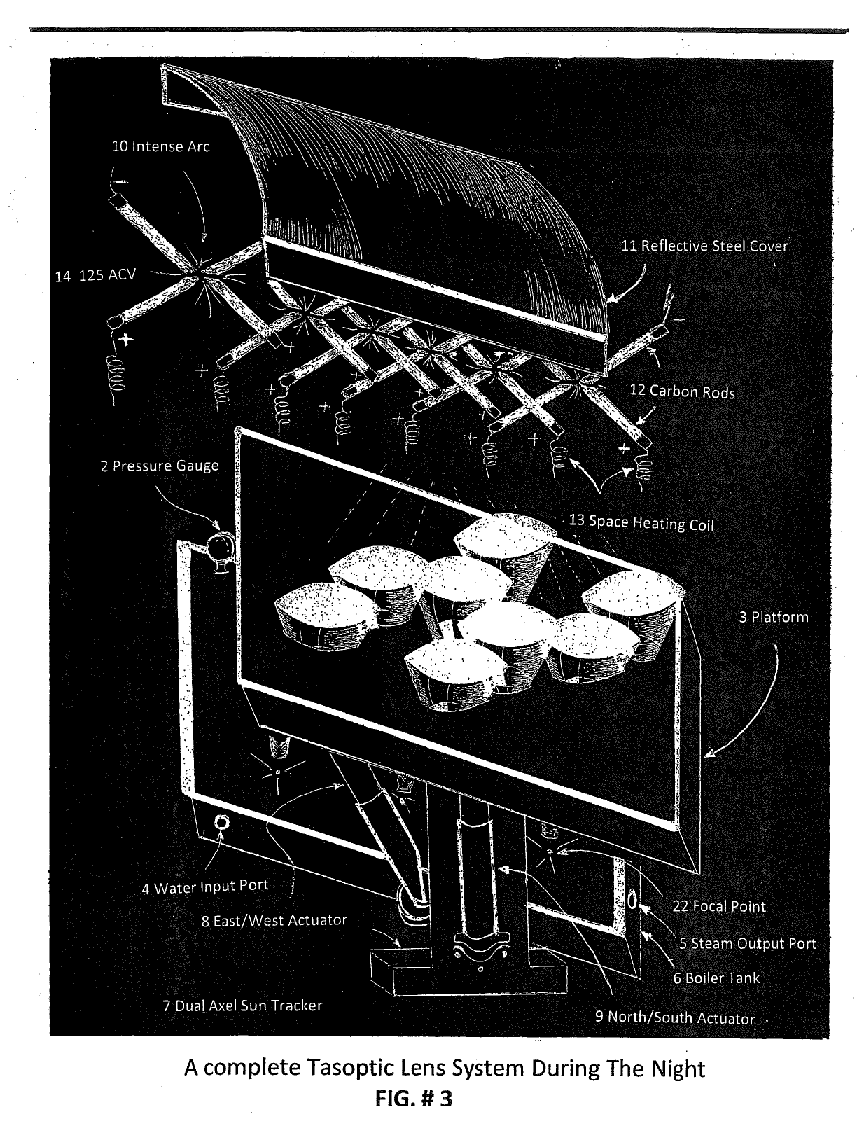

Referring to FIG. 3, an automatic sensor is integrated into the system to respond to the blackout of the sun and turn over the assembly of the carbon rods onto the top of the lenses to create a luminescent arc of white parallel light rays.

1. A solar energy system that produces intense heat for use in steam turbine engines and water purification processes comprised of:
a bank of four sets of Tasoptic biconvex octave lenses positioned one upon the other in mathematical orderliness in inverse cube ratio from top to bottom, each lens having a specific diameter, arc convexity and radius in each octave in compliance with the Geometry of Space and the Law of Octaves of Elements of Matter,
the first octave lens is the largest of them all and converges the sun's parallel rays in a 180° radius, compresses it four times and focuses it into the center of the second octave lens 160.00 mm (6.29 in) below itself. The size of the focal point is 4 mm in diameter,
the diameter of the first octave lens is 320.00 mm (12.59 in), has a radius and arc convexity of 226.28 mm (8.90 in) and a focal point of 160.00 mm (6.29 in),
the thickness of these lenses measuring from top dead center to bottom dead center is 132.54 mm (5.22 in),
the second octave lens is 160.00 mm (6.29 in) which is two times smaller in diameter and converges the sun's parallel rays, compresses it four more times and focuses it into the center of the third octave lens below itself,
the distance from the center of the second octave lens to the center of the third octave lens is two times smaller than the center of the first octave lens to the center of the second octave lens,
the diameter of the second octave lens is 160.00 mm (6.29 in), has a radius and arc convexity of 113.13 mm (4.45 in) and a focal point of 80.00 mm (3.15 in),
the thickness of these lenses measuring from top dead center to the bottom dead center is 66.28 mm (2.61 in),
the third octave lens is 80.00 mm (3.15 in) which two times smaller in diameter than the second octave lens and converges the sun's parallel rays, compresses it four more times and focuses it into the center of the fourth octave lens below itself,
the distance from the center of the third octave lens to the center of the fourth octave lens is two times smaller than the distance from the center of the second octave lens to the center of the third octave lens,
the diameter of the third octave lens is 80.00 mm (3.15 in), has a radius and arc convexity of 56.57 mm (2.23 in) and a focal point of 40.00 mm (1.57 in),
the thickness of these lenses measuring from top dead center to the bottom dead center is 33.14 mm (1.30 in),
the fourth octave lens is 40.00 mm (1.57 in) which is two times smaller in diameter than the third octave lens and converges the sun's parallel rays, compresses it four times and focuses it onto the surface of the steel boiler tank below itself,
the size of the focal points of these lenses are as small as a pinhead and may cut steel and vaporize water upon contact,
the distance from the center of the fourth octave lens to the focal point of the sun's rays onto the surface of the steel boiler tank is 20.00 mm (0.78 in) which is two times smaller than the distance from the center of the third octave lens to the center of the fourth octave lens,
the diameter of the fourth octave lens is 40.00 mm (1.57 in), has a radius and arc convexity of 28.29 mm (1.11 in) and a focal point of 20.00 mm (0.78 in),
the thickness of these lenses measuring from top dead center to the bottom dead center is 16.56 mm (0.65 in),
wherein all four biconvex octave lenses sit horizontally in mathematical orderliness upon one another in a cone in their octave positions,
wherein the cones are made of a half circle of metallic material having a reflective surface on the inside and form a 60° inclination from the apex to the base when it is folded into the shape of a cone,
wherein the inclination of the 60° accommodates for the positioning of the lenses to engage in their octave positions in mathematical orderliness in inverse cube ratio in compliance with the Geometry of Space and the Law of Octave of Elements of Matter,
wherein the diameters, arc radii and convexity of the lenses are fixed proportionately to the size of the diameter of the lenses and the scale of the application required.

2. A system according to claim 1, wherein more than 12 sets of four biconvex octave lenses or larger sizes of lenses may be constructed for producing larger volumes of heat and steam.

3. A system according to claim 1, wherein light guide tubes are attached to the apexes of the cone to divert the focal points onto the surface of the rectangular steel boiler.

4. A system according to claim 1, wherein a rectangular steel boiler tank may be filled with water or liquid Dynalene and has a finned copper tube coiled inside of it for pumping in water from one side and exiting as steam on the other side of it.

5. A system according to claim 1, wherein the steel boiler tank is fixed upon a dual actuator sun tracker to track the sun's movement from both east to west and north to south as well as to keep the surface of the lenses perpendicular at 90° to the sun's rays at all times.

6. A system wherein cold water is pumped in from the water input port to be spontaneously heated to steam and exits from a steam output port to be adapted onto a steam turbine engine.

7. A system wherein having an assembly of super conductive carbon rods constructed above the bank of Tasoptic lenses is required to simulate the sun's rays during the night and cloudy days.
a system according to claim 7, wherein one side of the assembly of the carbon rods is attached to the positive leads of electricity, and the other side of the assembly of the carbon rods is attached to the negative leads of electricity.
a system according to claim 7, wherein 1500 Watt space heating coils are attached between each pair of the positive poles of the carbon rods and positive leads of electricity.
a system according to claim 7, wherein a reflective concave mirror cover is constructed above the assembly of the carbon rods to increase the intensity and heat of the arc of the carbon rods and reflects it back onto the lenses.
